(19) United States
(12) Patent Application Publication
(10) Pub. No.: US 2003/0102287 A1
(43) Pub. Date: Jun. 5, 2003

(54) Tool, tool holder, and machine tool

(76) Inventors: Koji Katsumata, Shizuoka (JP); Sakashi Adachi, Shizuoka (JP)

Correspondence Address: PILLSBURY WINTHROP, LLP, P.O. BOX 10500, MCLEAN, VA, 22102, US

(21) Appl. No.: 10/305,132

(22) Filed: Nov. 27, 2002

(30) Foreign Application Priority Data
Nov. 30, 2001 (JP) 2001-367429

(51) Int. Cl. B23H 1/00; B23H 7/30

(52) U.S. Cl. 219/69.11; 219/69.13; 219/69.2

(57) ABSTRACT

A tool attachable to a machine tool in the same way as an ordinary tool, capable of being driven and operating without connecting with an external power supply etc., and made small enough to enable automatic changing, provided with a generator for generating power by energy of compressed air supplied from the outside, a motor driven by power generated by the generator, and a cutting tool driven by the motor for cutting the workpiece.

### BACKGROUND OF THE INVENTION

1. Field of the Invention

The present invention relates to a tool to be attached to a machine tool for machining a workpiece.

2. Description of the Related Art

In for example a machining center or other machine tool provided with a spindle, the maximum rotational speed of the spindle (per unit time) is determined by the structure of a main bearing rotatably holding the spindle and a lubrication system. For this reason, when desiring to rotate a tool at a higher rotational speed than the maximum rotational speed of the spindle, an accelerating apparatus is used.

As the accelerating apparatus, for example, one which holds the tool and is able to be attached to the spindle and which can increase the rotary force of the spindle by a gear mechanism such as epicyclic gearing to increase the rotational speed of the tool is known.

For example, in a machining center, when it is desired to increase the rotational speed of the tool to higher than the maximum speed of the spindle temporarily, such an accelerating apparatus is attached to the spindle in the same way as an ordinary tool to enable the tool to be rotated at a higher rotational speed.

However, when raising the rotational speed of the tool to a higher speed than the spindle by the above accelerating apparatus comprised of the gear mechanism, the accelerating apparatus increasingly generates heat at a super high rotational speed such as tens of thousands to hundreds of thousands of revolutions per minute, so the machining tolerance of a workpiece can be influenced by the heat. Further, at the above super high rotational speed, the noise from the accelerating apparatus can also increase. Furthermore, a highly reliable precision structure able to withstand the above super high rotational speed is required for the accelerating apparatus, so there is the disadvantage that the manufacturing cost becomes relatively high.

Further, in a case of an accelerating apparatus with a gear mechanism, it is needed to lubricate the gear or bearing and arrange a supply passage and a discharge passage for the lubricating oil in the accelerating apparatus, so there is the disadvantage that the apparatus becomes larger and it is difficult to automatically change the tool by an automatic tool changer.

Further, as another accelerating method, sometimes the method is adopted of using a high frequency motor for the motor driving the tool and supplying drive current to this high frequency motor from a specially provided control apparatus so as to rotate the tool at a high speed. With this method, however, since there is a cable for supplying electric power from the outside, there are the disadvantages that it is difficult to automatically change tools like with an ordinary tool and the cost of the facilities is relatively high.

### SUMMARY OF THE INVENTION

An object of the present invention is to provide a tool and a tool holder able to be attached to a spindle of a machine tool in the same way as an ordinary tool, capable of being driven or operating without connection with an external power supply etc., and made compact enough to be able to be changed automatically.

Another object of the present invention is to provide a machine tool provided with the above tool and tool holder.

According to a first aspect of the present invention, there is provided a tool attachable to a machine tool for machining a workpiece comprising a generator for generating power by fluid energy supplied from the outside and a machining means for machining a workpiece using power generated by the generator.

Preferably, the machining means is provided with a motor driven using power generated by the generator and a cutting tool driven by the generator for cutting the workpiece.

Alternatively, the machining means has an electric discharge machining electrode for electric discharge machining using power generated by the generator.

According to a second aspect of the present invention, there is provided a tool holder able to hold a cutting tool for machining a workpiece and attachable to a machine tool, comprising a generator for generating power by fluid energy supplied from the outside, a motor driven using power generated by the generator, and a holding means for holding the cutting tool for machining the workpiece so as to be able to transmit rotation of the motor.

According to a third aspect of the present invention, there is provided a tool holder able to hold an electric discharge machining electrode for electric discharge machining of a workpiece and attachable to a machine tool, comprising a generator for generating power by fluid energy supplied from the outside and a holding means for exchangeably holding the electric discharge machining electrode for electric discharge machining using power generated by the generator.

According to a fourth aspect of the present invention, there is provided a machine tool comprising a tool provided with a generator for generating power by fluid energy supplied from the outside and a machining means for machining a workpiece using power generated by the generator and a machine tool body to which the tool is attached, provided with a supply source for supplying fluid energy to the attached tool, and moving and positioning the tool with respect to the workpiece.

In the present invention, the tool for machining the workpiece has a built-in generator which generates power by fluid energy. By providing a supply source for supplying fluid energy to the machine tool body to which the tool is attached and supplying that fluid energy to the attached tool, power is generated. The generated power is used by the machining means to machine the workpiece.

For example, when the machining means is provided with a motor and a cutting tool, the cutting tool driven by the motor is moved and positioned with respect to the workpiece by the machine tool body for cutting work.

When the machining means is provided with an electric discharge machining electrode, power is supplied to the electric discharge machining electrode and the electrode is moved and positioned with respect to the workpiece by the machine tool body for electric discharge machining.

### BRIEF DESCRIPTION OF THE DRAWINGS

These and other objects and features of the present invention will be more apparent from the following description of the preferred embodiments given in relation to the accompanying drawings, wherein:

FIG. 1 is a view of the configuration of a vertical lathe as an example of a machine tool to which the present invention is applied;

FIG. 2 is a sectional view of the configuration of a tool according to a first embodiment of the present invention;

FIG. 3 is a function block diagram of the electrical system of the tool;

FIG. 4 is a sectional view of the configuration of a tool according to a second embodiment of the present invention;

FIG. 5 is a function block diagram of the electrical system of the tool shown in FIG. 4; and

FIG. 6 is a view for explaining electric discharge machining using the tool shown in FIG. 4.

### DESCRIPTION OF THE PREFERRED EMBODIMENTS

Below, an explanation will be made of embodiments of the present invention by referring to the drawings.

First Embodiment

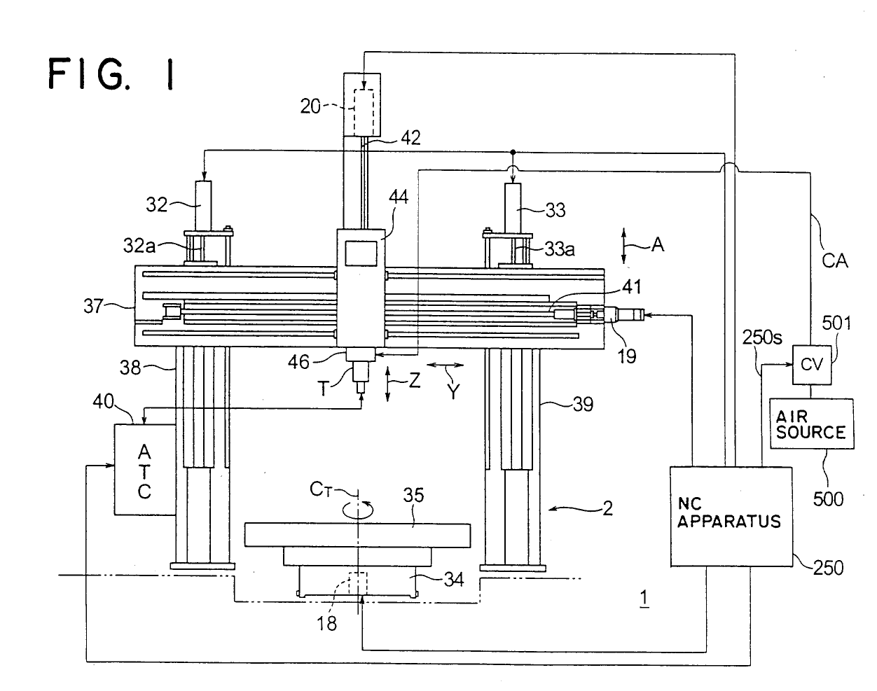

FIG. 1 is a view of the configuration of a vertical lathe as an example of a machine tool according to the present invention.

The vertical lathe 1 is provided with a machine tool body 2, a numerical control apparatus (NC apparatus) 250, and an air source 500.

In FIG. 1, the machine tool body 2 is provided with a pair of columns 38, 39, a cross rail 37 having two ends supported to be able to move in the vertical direction shown by the arrow A by the columns 38, 39, a saddle 44 supported on the cross rail 37 to be able to move in the horizontal direction shown by the arrow Y, a tool mounting member 46 held by the saddle 44 and provided to be able to move in the vertical direction shown by the arrow Z (Z-axis direction), and a rotary table 35 provided to be able to rotate on a base 34.

The saddle 44 is provided with a not illustrated nut part passing through the cross rail 37 in a horizontal direction. A feed shaft 41 with a screw part formed on the outer circumference is screwed into this nut part.

A servo motor 19 is connected with an end of the feed shaft 41. The feed shaft 41 is driven to rotate by the servo motor 19.

By the rotation of the feed shaft 41, the saddle 44 moves in the horizontal direction. By this, the tool mounting member 46 is moved and positioned in the Y-axis direction.

Further, the saddle 44 is provided with a not illustrated nut part in the vertical direction. The feed shaft 42 with a screw part formed on the outer circumference is screwed into this nut part. A servo motor 20 is connected with an end of the shaft 42.

The servo motor 20 drives the feed shaft 42 to rotate. By this, the tool mounting member 46 movably provided on the saddle 44 is moved and positioned in the vertical direction.

The tool mounting member 46 mounts various types of tools T used for lathing at its front end.

The rotary table 35 carries a workpiece to be machined. The rotary table 35 can rotate about a center axis CT. The rotary table 35 is rotated by a servo motor 18.

The rotary table 35 is positioned in the rotational direction by being driven by the servo motor 18.

Further, the gate type columns 38, 39 are provided with not illustrated nut parts. The cross rail 37 is raised and lowered by the rotation of the feed shaft 32a screwed into it by cross rail elevation servo motors 32 and 33.

An automatic tool changer (ATC) 40 automatically changes the tool T attached to the tool mounting member 46.

The automatic tool changer 40 stores in a not illustrated magazine tools T comprised of various cutting tools held by tool holders, returns a tool T attached to the tool mounting member 46 by a not illustrated tool changing arm into the magazine, and attaches a required tool T to the tool mounting member 46 by the tool changing arm.

The NC apparatus 250 controls the drive of the servo motors 18, 19, and 20 and the cross rail elevation servo motors 32, 33.

The NC apparatus 250 controls the positions and the speeds between a tool T and a workpiece by the servo motors 18, 19, 20, 32 and 33 according to a machining routine defined in advance in a machining program.

Further, the NC apparatus 250 automatically changes various tools by the automatic tool changer 40 by decoding the tool changing operation of the tool T defined by for example an M-code in the NC program.

The air source 500 is connected through a control valve 501 to the tool mounting member 46. The air source 500 supplies compressed air CA to the tool mounting member 46. The control valve 501 controls the pressure of the compressed air CA supplied from the air source 500 in accordance with a control instruction 250s from the NC apparatus 250.

The vertical lathe 1 of the above configuration basically fastens the workpiece on the rotary table 35, rotates the rotary table 35, and moves and positions the tool T attached to the tool mounting member 46 three-dimensionally with respect to the workpiece to cut the workpiece.

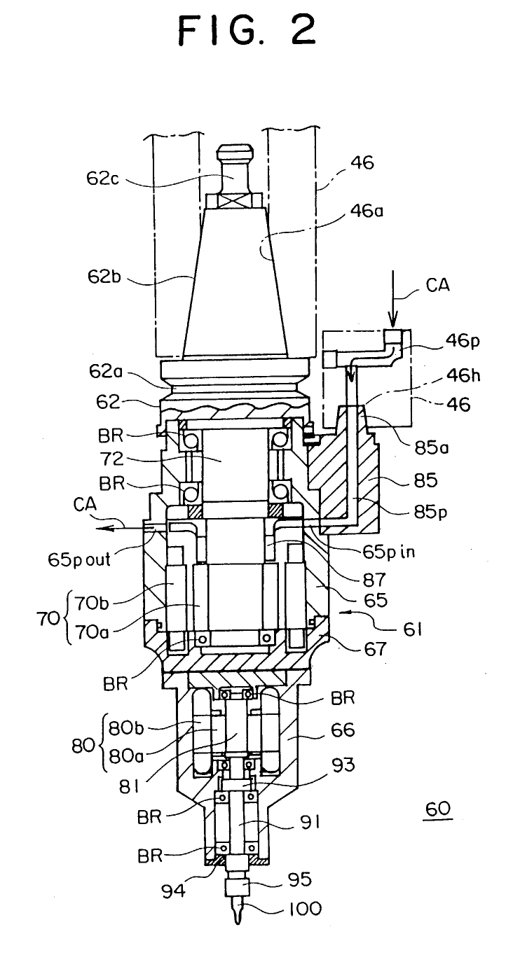

FIG. 2 is a sectional view of a tool according to the first embodiment of the present invention.

In FIG. 2, a tool 60 has a cutting tool 100 and a tool holder 61 for holding the cutting tool 100. Note that the tool 60 according to the present embodiment is attached to the tool mounting member 46 by the automatic tool changer 40 in the same way as the above ordinary tool T.

The tool holder 61 has an attachment part 62, a casing 65, a shaft 72, a generator 70, a rotor 87, a motor 80, and a locking part 85.

The attachment part 62 is provided with a grip 62a, a taper shank 62b to be attached to a taper sleeve 46a formed at the front end of the above tool mounting member 46, and a pull stud 62c formed at the front end of this taper shank 62b.

The attachment part 62 is fixed to the top end of the cylindrical casing 65.

The grip 62a of the attachment part 62 is gripped by the above tool changing arm of the automatic tool changer 40 when the tool 60 is being attached to the tool mounting member 46 from the magazine of the automatic tool changer 40 and when the tool 60 is being conveyed from the tool mounting member 46 to the magazine of the automatic tool changer 40.

The pull stud 62c of the attachment part 62 is clamped by a collet of a not illustrated clamping mechanism built in the tool mounting member 46 when the taper shank 62b of the attachment part 62 is attached to the taper sleeve 46a of the tool mounting member 46. Note that the clamping mechanism built in the tool mounting member 46 is well known, so a detailed explanation will be omitted.

The shaft 72 has a rotor 87 fixed to its middle part. The rotor 87, as explained later, rotates the shaft 72 by compressed air.

The shaft 72 has a rotor 70a of the generator 70 affixed to its bottom end. The casing 65 has a stator 70b of the generator 70 affixed to its inner circumference at a position facing the rotor 70a.

The generator 70 generates power at the winding side of the stator 70b by the rotation of the shaft 72. As the generator 70, for example, a three-phase synchronous generator can be used.

The casing 65 is formed with a supply pipe 65Pin to which the compressed air CA is supplied and a discharge pipe 65Pout for discharging the compressed air CA supplied inside the casing 65 to the outside of the casing 65 at positions facing the rotor 87.

The casing 65 has a motor casing 66 fastened to its bottom end through a bearing holding member 67 holding bearings BR for rotatably holding the bottom end of the shaft 72.

The motor casing 66 rotatably holds at its inner circumference a drive shaft 81 through a plurality of bearings BR.

The drive shaft 81 has a rotor 80a of a motor 80 affixed to it.

The motor casing 66 has a stator 80b affixed to its inner circumference at a position facing the rotor 80a.

As the motor 80, for example, a three-phase induction motor can be used.

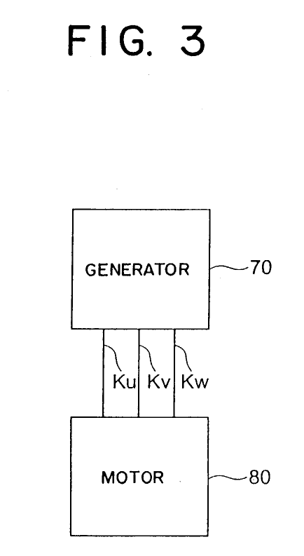

The motor 80 and the generator 70, as shown in FIG. 3, are electrically connected by a plurality of cables Ku, Kv, and Kw. The three-phase alternating current generated by the generator 70 is supplied to the motor 80 through the cables Ku, Kv, and Kw.

The front end of the drive shaft 81 is connected to a shaft 91 by a coupling 93. This shaft 91 is rotatably held at the inner circumference of the motor casing 66 through a plurality of bearings BR.

The front end of the shaft 91 is locked to the motor casing 66 by a locking member 94.

The front end of the shaft 91 has a cutting tool mounting member 95 affixed to it. The cutting tool mounting member 95 holds a cutting tool 100 exchangeably.

The cutting tool 100 cuts the workpiece. The cutting tool 100 specifically is a cutting tool such as a drill or end mill.

The casing 65 is provided with a locking member 85 at its outer circumference.

This locking member 85 engages at its front end 85a with an engagement hole 46h formed at part of the tool mounting member 46 by attachment of the attachment part 62 to the taper sleeve 46a of the tool mounting member 46. By this, the tool 60 is positioned in rotational position about its axial center.

The locking member 85 is formed with a pipeline 85p for supplying compressed air CA. One end of the pipeline 85p is connected with the above supply pipe 65Pin. The other end of the pipeline 85p is connected to a pipeline 46p for supplying compressed air CA formed at the tool mounting member 46 side. That is, by the engagement of the front end 85a of the locking member 85 with an engagement hole 46h formed at part of the tool mounting member 46, the pipeline 46 and pipeline 85p are connected and compressed air CA is supplied inside the casing 65 from the air source 500.

Next, an explanation will be made of an example of the operation of the tool 60 of the present embodiment.

First, the automatic tool changer 40 attaches the tool 60 holding the cutting tool 100 at the taper sleeve 46a of the tool mounting member 46 of the machine tool body 2.

The front end 85a of the locking member 85 is inserted into the engagement hole 46h of the tool mounting member 46.

By controlling the control valve 501 from this state, compressed air CA adjusted to a predetermined pressure is supplied from the air source 500. The supplied compressed air CA is supplied to the inside of the casing 65 through the pipeline 46p of the tool mounting member 46, the pipeline 85p of the locking member 85, and the supply pipe 65Pin of the casing 65.

The compressed air supplied inside the casing 65 is blown out toward the rotor 87. The rotor 87 rotates about the shaft 72 by the energy of the compressed air CA.

After acting on the rotor 87, the compressed air CA is discharged to the outside through the discharge pipe 65Pout formed in the casing 65.

By rotation of the shaft 72, the generator 70 generates power. The generator 70 generates three-phase alternating current power in the case of using a three-phase synchronous generator.

If rotating the shaft 72 by the rotational speed N₀ by the control of the control valve 501 at this time, the frequency F of the three-phase alternating current power generated by the generator is expressed by the following formula (1) when the number of poles of the generator 70 is PI and the rotational speed of the tool mounting member 46 is N₀ [min⁻¹]:

F=P₁×N₀/120[min] (1)

Accordingly, when the shaft 72 is rotated at the rotational speed Nₒ, a three-phase alternating current having the frequency F expressed the above formula (1) is supplied to the motor 80.

Here, in case where a three-phase induction motor is used as the motor 80, if the number of poles of the motor 80 is P₂, the motor 80 is rotated by 2/P₂ per cycle of the three-phase alternating current. Therefore, the synchronous rotational speed N₁ of the three-phase induction motor at the time of no slip is expressed by the following formula (2):

N₁=120*F/P₂[min⁻¹] (2)

Accordingly, the relationship of the rotational speed N₁ of the motor 80 to the rotational speed N₀ of the shaft 72 is expressed by the following formula (3):

N₁=N₀* P₁/P₂[min⁻¹] (3)

As understood from formula (3), the rotational speed N₀ of the shaft 72 is changed to the rotational speed N₁ expressed by the above formula (3).

As expressed by the formula (3), it is found that by appropriately setting the ratio between the number of poles P₁ of the three-phase synchronous generator and the number of poles P₂ of the three-phase induction motor, it is possible to freely set the ratio of the rotational speed N₁ of the cutting tool 100 to the rotational speed N₀ of the shaft 72.

That is, when trying to raise the speed over the rotational speed N₀ of the shaft 72, the ratio of the number of poles P₁/P₂ is set larger than 1. When trying to lower it, it is sufficient to select the number of poles P₁ of the three-phase synchronous generator and the number of poles P₂ of the three-phase induction motor so that the ratio P₁/P₂ becomes smaller than 1.

That is, by suitably setting the ratio of the number of poles P₁/P₂, it becomes possible to freely change the rotational speed of the motor 80 under conditions of a constant pressure of the compressed air CA.

In the state with the cutting tool 100 is rotating, the workpiece is cut by moving and positioning the tool 60 three-dimensionally with respect to the workpiece fixed on the table 35 in accordance with the machining program downloaded to the NC apparatus 250.

In this way, according to the present embodiment, by incorporating the generator 70 and motor 80 in the tool 60 formed as a unit in the same way as an ordinary tool and driving the motor 80 by the power generated by the generator 70, the cutting tool 100 can be rotated at the desired rotational speed, there is no increase in the heat buildup as with a gear device, and reduction of the machining tolerance is suppressed.

According to the present embodiment, since the motor 80 is directly connected to the cutting tool 100 and the inertia is relatively small, it is possible to easily rotate the cutting tool 100 at a high speed and possible to improve the response of the cutting tool 100 compared with when using a gear mechanism etc. to rotate a cutting tool 100 at a high speed.

According to the present embodiment, since the tool 60 is detachably attached to the tool mounting member 46 and can be changed by the automatic tool changer 40 in the same way as an ordinary tool, it is possible to immediately respond to a request for cutting by the tool in accordance with need while performing ordinary lathing at the vertical lathe 1.

According to the present embodiment, since compressed air CA is supplied to the tool mounting member 46, the energy of the compressed air CA is used to generate power at the generator 70, and the generated power is used to drive the cutting tool 100, there is no need to supply drive current from the outside and as a result no need for a cable for supplying power.

Second Embodiment

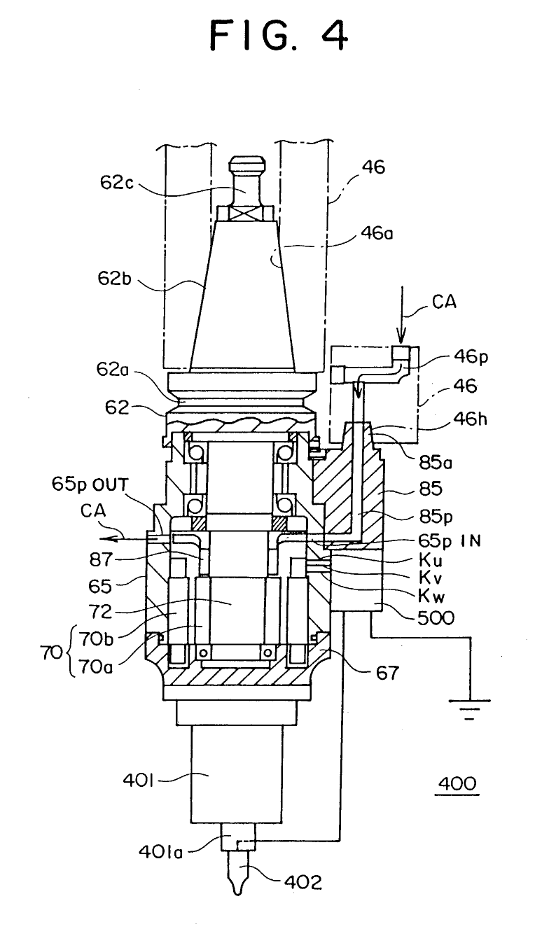

FIG. 4 is a sectional view of the configuration of a tool of another embodiment of the present invention. Note that in the tool shown in FIG. 4, the same reference numerals are used for parts the same as in the tool 60 of the first embodiment.

The tool 400 according to the present embodiment differs from the tool 60 according to the first embodiment in that the tool 400 has, in place of the motor 80, an electrode holding member 401 fixed to the bottom end of the casing 65 through a bearing holding member 67 and an electric discharge machining electrode 402 held by that electrode holding member 401 and has a rectifier 500 provided at the bottom end of the locking member 85.

The electrode holding member 401 is formed of an electrically insulating material such as a ceramic and is provided at its front end with a holder 401a for exchangeably holding an electric discharge machining electrode 402.

The electric discharge machining electrode 402 is used for electric discharge machining a workpiece. Electrodischarge machining is a heat machining method causing an arc discharge between the electrode and workpiece and using the heat action of the arc discharge to cause the workpiece to melt and evaporate for removal. Electrodischarge machining is characterized by the ability to machine any conductive material, regardless of hardness, to a close tolerance for even extremely complicated shapes. Therefore, it is widely used for making molds and dies for plastic injection molding machines or die casting machines.

The electric discharge machining electrode 402 is formed of a material such as a copper-tungsten alloy, a silver-tungsten alloy, copper-graphite, aluminum, iron, bronze, etc.

The electric discharge machining electrode 402 is cut to a predetermined shape in advance.

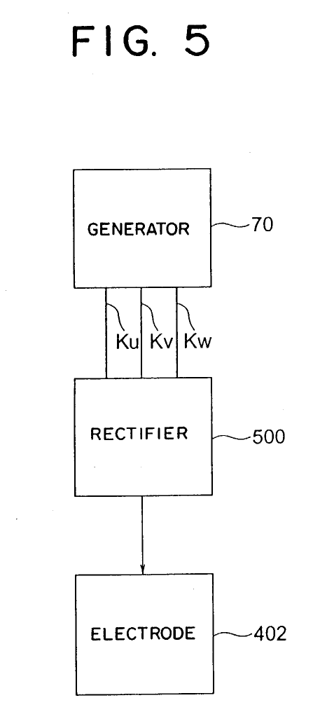

The rectifier 500, as shown in FIG. 5, is supplied with the three-phase alternating current generated by the generator 70 through conductor cables Ku, Kv, and Kw. The rectifier 500 converts the three-phase alternating current to current of a predetermined voltage and supplies it to the electric discharge machining electrode 402.

Next, an explanation will be given of an example of electric discharge machining by a vertical lathe using a tool 400 of the above configuration.

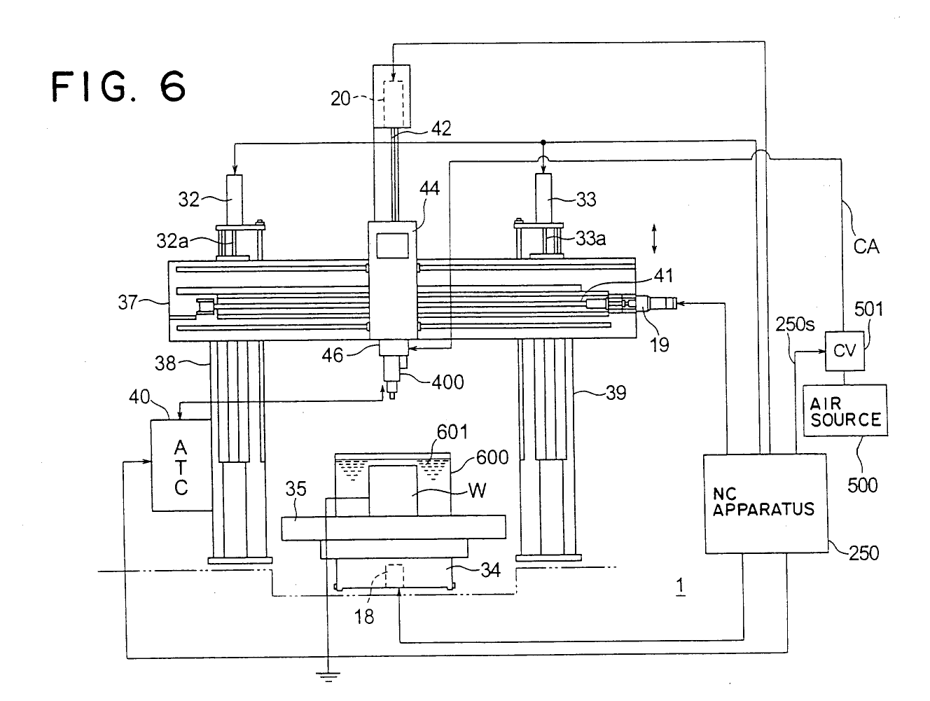

As shown in FIG. 6, the tool 400 is attached to the tool mounting member 46 by the automatic tool changer 40.

On the other hand, a working fluid tank 600 contain a working fluid 601 and the workpiece W is placed on the rotary table 35.

The working fluid 601 has an electrical insulation property. For example, an insulating oil is used.

The workpiece W is formed by a metal material. It is placed in the working fluid tank 600 and immersed completely in the working fluid 601. The workpiece W is grounded.

In the above state, compressed air CA is supplied from an air source 500 to the tool 400 to enable the generator 70 to generate power.

The power generated by the generator 70 is rectified at the rectifier 500. Direct current power of a predetermined voltage is therefore applied to the electric discharge machining electrode 402.

In the state with the electric discharge machining electrode 402 supplied with direct current power of a predetermined voltage, the electric discharge machining electrode 402 is made to descend toward the workpiece W in accordance with an NC program downloaded to the NC apparatus 250.

When the electric discharge machining electrode 402 is made to descend and the electric discharge machining electrode 402 approaches the workpiece W, the working fluid 601 undergoes dielectric breakdown at the portion of the least dielectric strength between the electric discharge machining electrode 402 and workpiece 402 and discharge occurs. The discharge immediately becomes an arc discharge and stabilizes. Since a locally extremely large energy flows from the arc column between the electric discharge machining electrode 402 and workpiece W, the parts of the electric discharge machining electrode 402 and workpiece W near the arc column are rapidly heated and evaporate or melt. Parts of the workpiece W are removed by this action.

If the electric discharge machining electrode 402 is further made to descend, the shape of the electric discharge machining electrode 402 is transferred to the workpiece W.

By moving the workpiece W and the electric discharge machining electrode 402 three-dimensionally in accordance with the NC program downloaded to the NC apparatus 250, the workpiece W is machined to the desired shape.

In this way, according to the present embodiment, by incorporating the generator 70 in the tool 400, using fluid energy to generate power at the generator 70, and performing electric discharge machining while supplying the generated power to the electric discharge machining electrode 402, it becomes unnecessary to supply power to the electric discharge machining electrode 402 from an outside power source.

Further, according to the present embodiment, it is possible to cut a workpiece by attaching various tools to the tool mounting member 46 of the vertical lathe 1 and, also, possible to easily perform electric discharge machining of a workpiece W by attaching the tool 400 to the tool mounting member 46 of the vertical lathe 1.

That is, according to the present embodiment, it becomes possible to use a vertical lathe 1 usually performing cutting work as an electric discharge machine tool by just attaching the tool 400 to the vertical lathe 1.

The present invention is not limited to the above embodiments.

In the above embodiments, the explanation was given of the case of using compressed air as the fluid and generating power by the energy of the compressed air, but for example it is also possible to generate power using oil pressure of an operating oil.

Summarizing the effects according to the present invention, a tool attachable to a machine tool in the same way as an ordinary tool, capable of being driven without connecting with an external power supply etc., and made small enough to enable automatic changing and a tool holder and machine tool provided with the same are obtained.

While the invention has been described with reference to specific embodiments chosen for purpose of illustration, it should be apparent that numerous modifications could be made thereto by those skilled in the art without departing from the basic concept and scope of the invention.

What is claimed is:

1. A tool attachable to a spindle of a machine tool for machining a workpiece comprising:
a generator for generating power by fluid energy supplied from the outside and
a machining means for machining the workpiece using power generated by said generator.

2. A tool as set forth in claim 1, wherein said machining means is provided with:
a motor driven using power generated by said generator and
a cutting tool driven by said generator for cutting the workpiece.

3. A tool as set forth in claim 1, wherein said machining means has an electric discharge machining electrode for electric discharge machining using power generated by said generator.

4. A tool holder able to hold a cutting tool for machining a workpiece and attachable to a machine tool, comprising:
a generator for generating power by fluid energy supplied from the outside,
a motor driven using power generated by said generator, and
a holding means for holding the cutting tool for machining the workpiece so as to be able to transmit rotation of said motor.

5. A tool holder able to hold an electric discharge machining electrode for electric discharge machining of a workpiece and attachable to a machine tool, comprising:
a generator for generating power by fluid energy supplied from the outside and
a holding means for exchangeably holding the electric discharge machining electrode for electric discharge machining using power generated by said generator.

6. A machine tool comprising:
a tool provided with a generator for generating power by fluid energy supplied from the outside and a machining means for machining a workpiece using power generated by said generator and
a machine tool body to which said tool is attached, provided with a supply source for supplying fluid energy to said attached tool, and moving and positioning said tool with respect to the workpiece.
